(19) United States
(12) Patent Application Publication
(10) Pub. No.: US 2023/0053854 A1
(43) Pub. Date: Feb. 23, 2023

(54) CLAMPING PLIER FACILITATING CUTTING

(71) Applicants: ZHUJI ITOP HARDWARE TOOLS CO., LTD., Zhuji (CN); ZHEJIANG IWISS ELECTRIC CO., LTD., Leqing (CN)

(72) Inventor: Yuejuan SHEN, Zhuji (CN)

(73) Assignees: ZHUJI ITOP HARDWARE TOOLS CO., LTD., Zhuji (CN); ZHEJIANG IWISS ELECTRIC CO., LTD., Leqing (CN)

(21) Appl. No.: 17/445,235

(22) Filed: Aug. 17, 2021

(51) Int. Cl. B25B 7/22; B23D 29/02

(52) U.S. Cl. CPC B25B 7/22; B23D 29/023

(57) ABSTRACT

A clamping plier facilitating cutting includes two heads and two handles. One of the two heads has a blade in at least one position, and the other one of the two heads has a blunt cut at a corresponding position. The two handles are respectively and integrally connected with the two heads in one-to-one correspondence, and the two heads or the two handles are rotatably connected together, so that the two heads are opened or closed by operating the two handles. When the two heads are closed, a blade of one of the two heads is attached to a plane of the blunt cut of the other one of the two heads to cut the cable. The blade of one of the two heads is easier to fit closely with the plane of the blunt cut of the other one of the two heads.

### TECHNICAL FIELD

The disclosure relates to a clamping plier, in particular to a clamping plier facilitating cutting.

### BACKGROUND ART

A clamping plier is a tool dedicated for installing and cutting cables. Like a scissor, a clamping plier has left and right heads, which are rotatably cross-connected together through a pin shaft. The two heads can be operated to open or close a jaw to cut cables and connect corresponding cables with a metal nose. However, people who have experience of using the clamping plier know that after the clamping plier is used for a certain period of time, blades of the two heads are prone to untight fitness, resulting in a gap, which results that the two blades cannot apply a shear force to the cables well, thus failing to cut the cables well.

### SUMMARY

A purpose of the disclosure is to provide a clamping plier facilitating cutting, and to solve a problem of different cutting or no cutting of a cable due to untight fitness of two heads of an existing clamping plier.

In order to solve the above problem, the disclosure provides a clamping plier facilitating cutting, which includes two heads and two handles. One of the two heads has a blade in at least one position, and the other one of the two heads has a blunt cut at a corresponding position. The two handles are respectively and integrally connected with the two heads in one-to-one correspondence, and the two heads or the two handles are rotatably connected together, so that the two heads are opened or closed by operating the two handles. When the two heads are closed, a blade of one of the two heads is attached to a plane of the blunt cut of the other one of the two heads to cut the cable.

According to an embodiment of the disclosure, the blade and the blunt cut are both located at a jaw position of the head or at a middle position which can be used for a clamping section. According to an embodiment of the disclosure, the blade is connected to the head in a damascene manner.

According to an embodiment of the disclosure, a side edge of the blade is provided with a bulge or notch, and the head is provided with a mounting groove matched with the blade. The mounting groove is provided with a notch or a bulge matched with the bulge or notch of the blade, and the blade is embedded in the mounting groove.

According to an embodiment of the disclosure, the blade is integrally foimed on the head.

According to an embodiment of the disclosure, the two heads have engagement teeth.

According to an embodiment of the disclosure, the engagement teeth are wave-shaped, peak-shaped or trapezoidal teeth.

According to an embodiment of the disclosure, the two handles are rotatably cross-connected together through a pin shaft, and ends of the two heads are each provided with a first connecting hole and ends of the two handles are each provided with a first connecting hole, and a pin shaft or screw passes through the first connecting hole of each of the two handles and the first connecting hole of each of the two heads to connect the heads and the handles together.

According to an embodiment of the disclosure, the middle positions of the two heads are each provided with a second connecting hole, and the clamping plier facilitating cutting also have two fixing pins and two cover plates. Each of the cover plates has two through holes distributed at intervals, and the two cover plates are respectively located at two sides of the heads, so that the two heads are both located between the two cover plates, and the two fixing pins both pass through one of the through holes of each of the two cover plates and the second connecting hole of one of the heads, so that the two cover plates and the two heads can be connected with each other and the two heads respectively and correspondingly rotate around the two fixing pins.

According to an embodiment of the disclosure, the clamping plier facilitating cutting further includes a positioning shaft, two heads are each provided with a positioning notch matched with the positioning shaft, and the positioning notches of the two heads are respectively positioned at two sides of the positioning shaft and are matched with the positioning shaft, and the positioning shaft is located in a space formed by the positioning notches of the two heads.

Compared with the prior art, the technical scheme has the following advantages:

In this disclosure, the blade is provided in one of the two heads, while the other one of the two heads is designed with a blunt cut at a corresponding position. Because the blunt cut is not sharp in shape, compared with a traditional scheme in which both heads are each designed with a blade, the blade of one of the two heads of this disclosure is easier to fit closely with the plane of the blunt cut of the other one of the two heads, thus making it easier to cut the cable. In addition, it is more difficult for the blunt cut to be worn, which can not only prolong service life of the whole clamping plier facilitating cutting, but also greatly delay a situation where the two heads are not tightly matched and cannot function to cut off due to wearing.

### BRIEF DESCRIPTION OF THE DRAWINGS

FIG. 1 is a structural schematic diagram of the clamping plier facilitating cutting according to a first embodiment of the disclosure.

FIG. 2 is a structural schematic diagram of the clamping plier facilitating cutting according to a second embodiment of the disclosure.

FIG. 3 is a structural schematic diagram of the clamping plier facilitating cutting according to a third embodiment of the disclosure.

### DETAILED DESCRIPTION

The following description is only intended to disclose the disclosure so as to enable those skilled in the art to implement the disclosure. The embodiments in the following description are by way of example only, and other obvious variations will occur to those skilled in the art. The basic principle of the disclosure defined in the following description can be applied to other implementations, modified, improved and equivalent schemes and other schemes without departing from the spirit and scope of the disclosure.

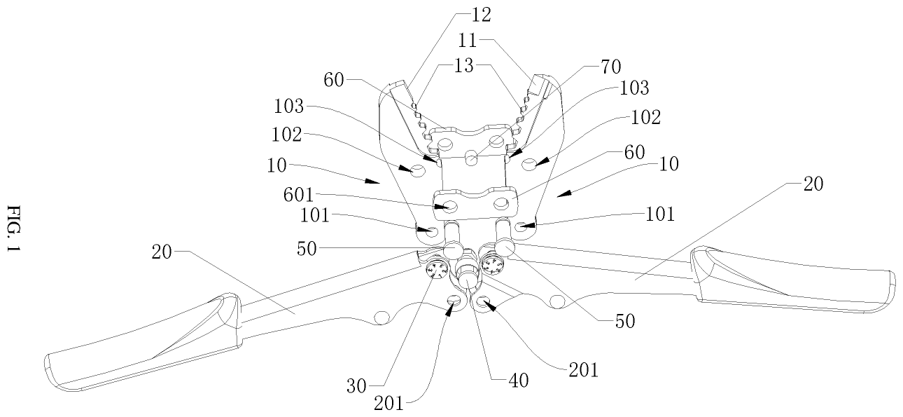

As shown in FIG. 1, in a first embodiment of the disclosure, a clamping plier facilitating cutting is provided, and the clamping plier facilitating cutting includes two heads 10 and two handles 20.

One of the two heads 10 has a blade 11 in at least one position, and the blade 11 is sharp in shape. While the other one of the two heads 10 has a blunt cut 12 at a corresponding position, that is, a position of the blunt cut 12 corresponds to a position of the blade 11, both of them are collectively used to cut the cable. The blade 11 is integrally formed with the heads 10. The blunt cut 12 is square in shape and has a plane for cutting. The blade 11 and the blunt cut 12 are both located at a jaw position of the heads 10. The jaw position here refers to an end position of the heads 10 away from the handle 20 as shown in FIG. 1. The two heads 10 both have engagement teeth 13, which can be of various existing tooth shapes. For example, in the first embodiment, the engagement teeth 13 are wave-shaped. The blade 11 is adjacent to the engagement teeth 13, and the blade 11 and a plurality of engagement teeth 13 are distributed on a side edge of one of the heads 10. While the blunt cut 12 is adjacent to the engagement teeth 13, and the blunt cut 12 and a plurality of engagement teeth 13 are distributed on a side edge of the other one of the heads 10. The other ends of the two heads 10 are each provided with a first connecting hole 101, and the middle positions of the two heads 10 are each provided with a second connecting hole 102. Both of the heads 10 are each provided with a positioning notch 103.

The two handles 20 are respectively and integrally connected with the two heads 10 in one-to-one correspondence, that is, one of the heads 10 is integrally connected with one of the handles 20, while the other one of the heads 10 is integrally connected with the other one of the handles 20. Specifically, as shown in FIG. 1, ends of the two handles 20 are each provided with a first connecting hole, and a pin shaft or screw 30 passes through the first connecting hole of each of the two handles 20 and the first connecting hole 101 of each of the two heads 10 to connect the heads 10 and the handles 20 together.

The two heads 10 or the two handles 20 are rotatably cross-connected together by a pin shaft, so that the two heads 10 are opened or closed together by operating the two handles 20. For example, as shown in FIG. 1, in the first embodiment, the clamping plier facilitating cutting also includes a pin shaft 40. The two handles 20 each have a second connecting hole 201, the second connecting holes 201 of the two handles 20 are aligned, and the pin shaft 40 passes through the second connecting holes 201 of the two handles 20 in turn, so that the two handles 20 can be rotatably cross-connected together by the pin shaft 40, and the two handles 20 can rotate around the pin shaft 40. Since the handles 20 and the heads 10 are connected integrally, the two heads 10 can be opened or closed synchronously by opening or closing the two handles 20. In order to facilitate the user to hold the handle 20, an outer circumference of the handle 20 is also sleeved with a sheath.

In addition, the clamping plier facilitating cutting also includes two fixing pins 50 and two cover plates 60, and each of the two cover plates 60 has two through holes 601 distributed at intervals. The two cover plates 60 are respectively located at two sides of the heads 20, so that the two heads 10 are both located between the two cover plates 60. The two fixing pins 60 both pass through one of the through holes 601 of each of the two cover plates 60 and the second connecting hole 102 of one of the heads 10, so that the two cover plates 60 and the two heads 10 can be connected with each other and the two heads 10 respectively and correspondingly rotate around the two fixing pins 50.

The clamping plier facilitating cutting further includes a positioning shaft 70, and the positioning notches 103 of the two heads 10 are each matched with the positioning shaft 70. The positioning notches 103 of the two heads 10 are respectively positioned at two sides of the positioning shaft 70 and are matched with the positioning shaft 70, and the positioning shaft 70 is located in a space foimed by the positioning notches 103 of the two heads 10. It is worth mentioning that in other embodiments, the positioning shaft 80 can also be removed in the cutting plier for preventing the blade from loosening and shifting.

When using the clamping plier facilitating cutting, a user holds the two handles 20 and opens or closes the two handles 20 together, and the two handles 20 correspondingly drive the two heads 10 to rotate around the fixing pins 50, so that the two heads 10 are synchronously opened or closed, thereby cutting the cable placed between the two heads 10. When the two heads 10 are closed together, the blade 11 of one of the two heads 10 is attached to a plane for cutting of the blunt cut 12 the other one of the two heads 10, so as to cut off the cable placed between the two heads 10.

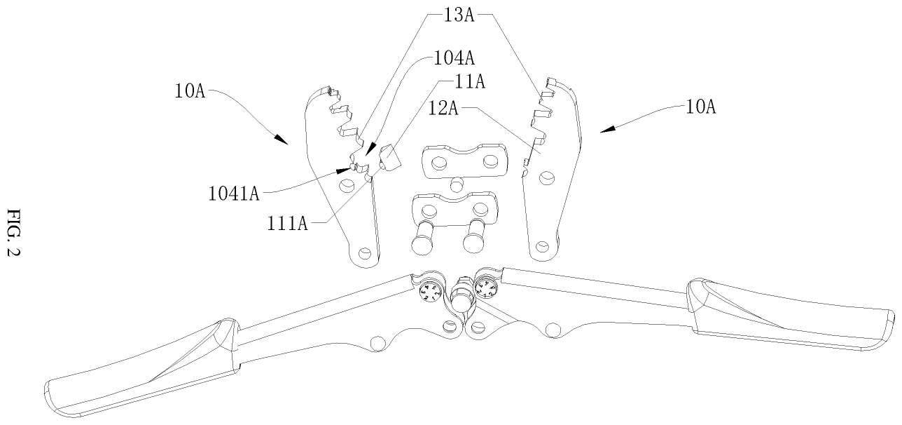

As shown in FIG. 2, a structure of the clamping plier facilitating cutting according to a second embodiment of this disclosure is substantially the same as that of the first embodiment, except that in the second embodiment, the blade 11A is connected to one of the two heads 10A in a damascene manner. Specifically, a side edge of the blade 11A is provided with a bulge 111A, and the head 10A is provided with a mounting groove 104A matched with the blade 11A, and the mounting groove 104A is provided with a notch 1041A matched with the bulge 111A, the blade 11A is embedded in the mounting groove 104A and the bulge 111A is embedded in the notch 1041A in the mounting groove 104A. It can be understood that compared with a implementation in which the blade is integrally foimed on the head, the blade 11A is connected to the head 10A in a damascene manner, which facilitates replacement and maintenance of the blade 11A. Once the blade 11A is damaged or worn, it is not necessary to discard the entire clamping plier. Secondly, the blade 11A can be manufactured independently, which facilitates its processing and shaping. Thirdly, with an increased service time, two opposite side edges of the blade 11A contacting an inner wall of the mounting groove 104 gradually wear due to an applied force, which leads to the blade 11A running off the mounting groove 104A. However, in this embodiment, the blade 11A can be positioned by matching the notch 1041 and the bulge 111A, and even if the edge of the blade 11A wears, it can still be positioned in the middle of the mounting groove 104A.

It can be understood that in other embodiments, a notch can be provided at one side edge of the blade 11A, and a bulge can be provided in the inner wall of the mounting groove 104A, so that the blade 11A can also be embedded into the mounting groove 104A, and the notch of the blade 11A is matched with the bulge in the mounting groove 104A.

In addition, the blade 11A is not located at the jaw position of the head 10A, but at a middle position of the head 10A which can be used for a clamping section. Since positions of the blade 11A and the blunt cut 12A correspond to each other, the blunt cut 12A is correspondingly located at the middle position of the other one of the two heads 10A. In a practical application, a shape of the head 10A and the positions of the blade 11A and the blunt cut 12A in the head 10A can be designed according to actual needs.

In the second embodiment, shapes of the engagement teeth 13A of the head 10A are different from those of the first embodiment, and the engagement teeth 13A are trapezoidal in shape and have an arc surface on an end face of the engagement teeth 13A.

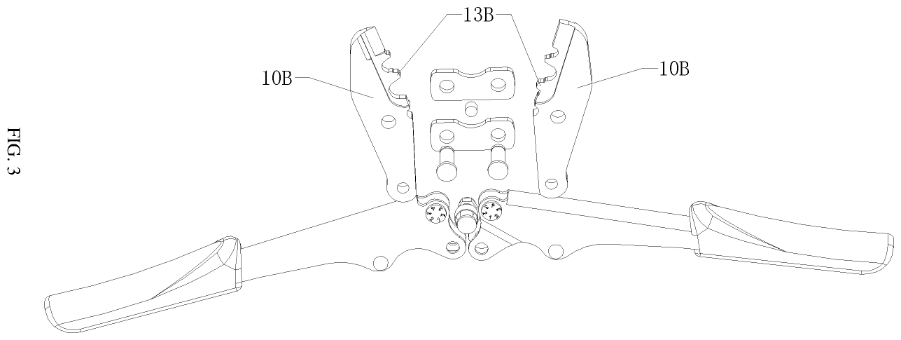

As shown in FIG. 3, a structure of the clamping plier facilitating cutting according to the third embodiment of this disclosure is substantially the same as that of the first embodiment, except that both the shapes and number of the engagement teeth 13B of the head 10B are different, and the engagement teeth 13B are mountain-shaped, and each head 10B only has two teeth 13B. In a practical application, the shapes and number of the engagement teeth 13B of the head 10B can be flexibly designed as required.

Those skilled in the art should understand that the above description and the embodiments of the disclosure shown in the drawings are only taken as examples and do not limit the disclosure. The purpose of the disclosure has been completely and effectively achieved. The function and structural principle of the disclosure have been shown and explained in the embodiment; any variation and modification can be made to the embodiments of the disclosure without departing from the principle.

What is claimed is:

1. A clamping plier facilitating cutting, comprising:
two heads, wherein one of the two heads has a blade in at least one position, and the other one of the two heads has a blunt cut at a corresponding position; and
two handles, wherein the two handles are respectively and integrally connected with the two heads in one-to-one correspondence, the two heads or the two handles being rotatably connected together, so that the two heads are opened or closed by operating the two handles; wherein when the two heads are closed, a blade of one of the two heads is attached to a plane of the blunt cut of the other one of the two heads to cut a cable.

2. The clamping plier facilitating cutting according to claim 1, wherein the blade and the blunt cut are both located at a jaw position of the head or at a middle position which can be used for a clamping section.

3. The clamping plier facilitating cutting according to claim 1, wherein the blade is connected to the head in a damascene manner.

4. The clamping plier facilitating cutting according to claim 3, wherein a side edge of the blade is provided with a bulge or notch, and the head is provided with a mounting groove matched with the blade, the mounting groove is provided with a notch or a bulge matched with the bulge or notch of the blade, and the blade is embedded in the mounting groove.

5. The clamping plier facilitating cutting according to claim 1, wherein the blade is integrally formed on the head.

6. The clamping plier facilitating cutting according to claim 1, wherein the two heads both have engagement teeth.

7. The clamping plier facilitating cutting according to claim 6, wherein the engagement teeth are wave-shaped, peak-shaped or trapezoidal teeth.

8. The clamping plier facilitating cutting according to claim 1, wherein the two handles are rotatably cross-connected together by a pin shaft, and ends of the two heads are each provided with a first connecting hole and ends of the two handles are each provided with a first connecting hole, and a pin shaft or screw passes through the first connecting hole of each of the two handles and the first connecting hole of each of the two heads to connect the heads and the handles together.

9. The clamping plier facilitating cutting according to claim 1, wherein the middle positions of the two heads are each provided with a second connecting hole, and the clamping plier facilitating cutting also have two fixing pins and two cover plates, each of the cover plates has two through holes distributed at intervals, and the two cover plates are respectively located at two sides of the heads, so that the two heads are both located between the two cover plates, and the two fixing pins both pass through one of the through holes of each of the two cover plates and the second connecting hole of one of the heads, so that the two cover plates and the two heads be connected with each other and the two heads respectively and correspondingly rotate around the two fixing pins.

10. The clamping plier facilitating cutting according to claim 9, wherein the clamping plier facilitating cutting further comprises a positioning shaft, two heads are each provided with a positioning notch matched with the positioning shaft, and the positioning notches of the two heads are respectively positioned at two sides of the positioning shaft and are matched with the positioning shaft, and the positioning shaft is located in a space formed by the positioning notches of the two heads.

11. The clamping plier facilitating cutting according to claim 4, wherein the two handles are rotatably cross-connected together by a pin shaft, and ends of the two heads are each provided with a first connecting hole and ends of the two handles are each provided with a first connecting hole, and a pin shaft or screw passes through the first connecting hole of each of the two handles and the first connecting hole of each of the two heads to connect the heads and the handles together.

12. The clamping plier facilitating cutting according to claim 7, wherein the two handles are rotatably cross-connected together by a pin shaft, and ends of the two heads are each provided with a first connecting hole and ends of the two handles are each provided with a first connecting hole, and a pin shaft or screw passes through the first connecting hole of each of the two handles and the first connecting hole of each of the two heads to connect the heads and the handles together.

13. The clamping plier facilitating cutting according to claim 4, wherein the middle positions of the two heads are each provided with a second connecting hole, and the clamping plier facilitating cutting also have two fixing pins and two cover plates, each of the cover plates has two through holes distributed at intervals, and the two cover plates are respectively located at two sides of the heads, so that the two heads are both located between the two cover plates, and the two fixing pins both pass through one of the through holes of each of the two cover plates and the second connecting hole of one of the heads, so that the two cover plates and the two heads be connected with each other and the two heads respectively and correspondingly rotate around the two fixing pins.

14. The clamping plier facilitating cutting according to claim 7, wherein the middle positions of the two heads are each provided with a second connecting hole, and the clamping plier facilitating cutting also have two fixing pins and two cover plates, each of the cover plates has two through holes distributed at intervals, and the two cover plates are respectively located at two sides of the heads, so that the two heads are both located between the two cover plates, and the two fixing pins both pass through one of the through holes of each of the two cover plates and the second connecting hole of one of the heads, so that the two cover plates and the two heads be connected with each other and the two heads respectively and correspondingly rotate around the two fixing pins.

15. The clamping plier facilitating cutting according to claim 8, wherein the middle positions of the two heads are each provided with a second connecting hole, and the clamping plier facilitating cutting also have two fixing pins and two cover plates, each of the cover plates has two through holes distributed at intervals, and the two cover plates are respectively located at two sides of the heads, so that the two heads are both located between the two cover plates, and the two fixing pins both pass through one of the through holes of each of the two cover plates and the second connecting hole of one of the heads, so that the two cover plates and the two heads be connected with each other and the two heads respectively and correspondingly rotate around the two fixing pins.

16. The clamping plier facilitating cutting according to claim 13, wherein the clamping plier facilitating cutting further comprises a positioning shaft, two heads are each provided with a positioning notch matched with the positioning shaft, and the positioning notches of the two heads are respectively positioned at two sides of the positioning shaft and are matched with the positioning shaft, and the positioning shaft is located in a space formed by the positioning notches of the two heads.

17. The clamping plier facilitating cutting according to claim 14, wherein the clamping plier facilitating cutting further comprises a positioning shaft, two heads are each provided with a positioning notch matched with the positioning shaft, and the positioning notches of the two heads are respectively positioned at two sides of the positioning shaft and are matched with the positioning shaft, and the positioning shaft is located in a space formed by the positioning notches of the two heads.

18. The clamping plier facilitating cutting according to claim 15, wherein the clamping plier facilitating cutting further comprises a positioning shaft, two heads are each provided with a positioning notch matched with the positioning shaft, and the positioning notches of the two heads are respectively positioned at two sides of the positioning shaft and are matched with the positioning shaft, and the positioning shaft is located in a space formed by the positioning notches of the two heads.

19. The clamping plier facilitating cutting according to claim 1, wherein the blade and a plurality of first engagement teeth are distributed on a side edge of one of the heads, the blade is adjacent to the first engagement teeth; the blunt cut and a plurality of second engagement teeth are distributed on a side edge of the other one of the heads, the blunt cut is adjacent to the second engagement teeth, and the first engagement teeth and the second first engagement teeth cooperate with each other.
